(19) United States
(12) Patent Application Publication
(10) Pub. No.: US 2006/0142461 A1
(43) Pub. Date: Jun. 29, 2006

(54) Moldings from reinforced polyurethane-urea elastomers and their use

(75) Inventors: Peter Haas, Haan (DE); Hans-Detlef Arntz, Lohmar (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/305,937

(22) Filed: Dec. 19, 2005

(30) Foreign Application Priority Data
Dec. 24, 2004 (DE) 102004062550.6

(51) Int. Cl. C08K 3/34

(52) U.S. Cl. 524/445

(57) ABSTRACT

The invention relates to moldings from polyurethane-urea elastomers with specific urea and urethane contents, containing reinforcing agents, and to their use.

### FIELD OF THE INVENTION

The invention relates to moldings from polyurethane-urea elastomers with specific urea and urethane contents, containing reinforcing agents, and to their use.

### BACKGROUND OF THE INVENTION

The preparation of polyurethane-urea elastomers by reacting NCO semi-prepolymers with mixtures of aromatic diamines and higher-molecular compounds containing hydroxyl or amino groups is known and is described e.g. in EP-A 225 640. To achieve specific mechanical properties in the moldings produced therefrom, it is necessary to add reinforcing agents to the reactants, especially in order to improve thermomechanical properties and substantially increase the flexural modulus. However, the use of these reinforcing agents also changes the longitudinal and transverse shrinkage properties of the moldings produced.

It is therefore desirable to have reinforced polyurethane-urea elastomers which exhibit an approximately isotropic behavior, i.e. the smallest possible difference in longitudinal and transverse shrinkage properties, in the production of sheet moldings such as car wings, doors or rear flaps.

Furthermore, the moldings produced from the reinforced polyurethane elastomers should be easily releasable from the molds, with the smallest possible addition of release agents, in order to ensure the longest possible cycle times by means of a quick-release system.

In EP-A 1 004 606 good release properties for the reinforced PUR-urea elastomers were obtained by increasing the functionality of the polyol reactant to 4-8 and the functionality of the polyol component used in the preparation of the isocyanate prepolymer component to 3-8.

When the contents of polyurea segments in the elastomer are high (even 85 to 90 mol %, based on mol % of an NCO equivalent), the elastomer exhibits a high degree of embrittlement. Such moldings easily break under flexural stress.

### SUMMARY OF THE INVENTION

The present invention therefore provides moldings which have good thermomechanical properties, a high flexural modulus, low shrinkage in the longitudinal and transverse directions, good release properties and short residence times.

This was achieved by the addition of specific rubber gels to the elastomer, allowing a substantial improvement in the flexural behavior of the elastomer compared with the state of the art.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The present invention provides polyurethane-urea elastomers containing reinforcing agents and having a urea content of 70 to 95 mol % and a urethane content of 5 to 30 mol %, based in each case on mol % of an NCO equivalent, the elastomers produced by reacting

a component A containing

A1) one or more aromatic diamines having an alkyl substituent in at least one ortho position to the amino groups,
A2) at least one aliphatic component containing at least one of a polyetherpolyol and a polyesterpolyol having a number-average molecular weight of from 500 to 18,000 and having a functionality of from 3 to 8 and having at least one of hydroxyl and primary amino groups,
A3) a reinforcing agent, and
A4) optionally catalysts and/or optionally additives,
   and a component B produced by reacting
B1) a polyisocyanate component chosen from polyisocyanates and polyisocyanate mixtures of the diphenylmethane series and liquefied polyisocyanates of the diphenylmethane series, with
B2) at least one polyol component having a number-average molecular weight of from 500 to 18,000 and a functionality of from 3 to 8 chosen from polyetherpolyols, optionally containing organic fillers, and polyesterpolyols, optionally containing organic fillers,
   wherein at least one of component A and component B contain rubber gels (C) modified by groups reactive towards isocyanate groups.

The modified rubber gels (C) substantially improve the tenacity properties of the polyurethane-urea elastomers, especially those with a high polyurea content.

The proportion of modified rubber gels (C) in the non-reinforced elastomer is preferably 0.5 to 25 wt. %, more preferably 2.5 to 20 wt. %.

The component A and the component B are reacted in proportions such that the isocyanate index of the elastomer obtained preferably ranges from 80 to 120 and the polyol component B2) introduced via the component B is 10 to 90 mol % of the urethane content.

The crosslinked rubber particles, or so-called rubber gels, used are especially those obtained by appropriate crosslinking of the following rubbers:

| | |
|---|---|
| BR: | polybutadiene, |
| ABR: | butadiene/C₁-C₄-alkyl acrylate copolymers, |
| IR: | polyisoprene, |
| SBR: | styrene/butadiene copolymers with styrene contents of |
| | 1 to 60, preferably of 5 to 50 wt. %, |
| X-SBR: | carboxylated styrene/butadiene copolymers, |
| FKM: | fluorinated rubber, |
| ACM: | acrylate rubber, |
| NBR: | polybutadiene/acrylonitrile copolymers with acrylonitrile |
| | contents of 5 to 60, preferably of 10 to 50 wt. %, |
| X-NBR: | carboxylated nitrile rubbers, |
| CR: | polychloroprene, |
| IIR: | isobutylene/isoprene copolymers with isoprene contents |
| | of 0.5 to 10 wt. %, |
| BIIR: | brominated isobutylene/isoprene copolymers with |
| | bromine contents of 0.1 to 10 wt. %, |
| CIIR: | chlorinated isobutylene/isoprene copolymers with |
| | bromine contents of 0.1 to 10 wt. %, |
| HNBR: | partially and fully hydrogenated nitrile rubbers, |
| EPDM: | ethylene/propylene/diene copolymers, |
| EAM: | ethylene/acrylate copolymers, |
| EVM: | ethylene/vinyl acetate copolymers, |
| CO and ECO: | epichlorohydrin rubbers. |

Particularly preferred rubbers are especially those functionalized by hydroxyl, carboxyl, amino and/or amide groups.

Functional groups can be introduced directly during the polymerization by copolymerization with suitable co-monomers, or after the polymerization by polymer modification. The hydroxy-functional esters of acrylic and methacrylic acids are particularly suitable for this purpose.

The reinforced polyurethane elastomers used preferably have a urea content of 75 to 90 mol % and a urethane content of 10 to 25 mol %, based on mol % of an NCO equivalent.

Particularly preferably, the component A and the component B are reacted in proportions such that the isocyanate index of the elastomer obtained preferably ranges from 90 to 115 and the polyol component B2) introduced via the component B is 30 to 85 mol % of the urethane content.

The reinforcing agents used are preferably those which are of an inorganic nature and have a laminar and/or acicular structure. In particular they are silicates of main groups II and III of the periodic table, such as calcium silicates of the wollastonite type and aluminum silicates of the mica or kaolin type. Such silicate-based reinforcing agents are known as sorosilicates, cyclosilicates, inosilicates or phyllosilicates and are described e.g. in Hollemann-Wiberg, W. de Gruyter Verlag (1985), 768 to 778.

These reinforcing agents have a diameter or a plate height or thickness of 2 to 30 μm and a linear dimension of 10 to 600 μm and their length/diameter ratio ranges from 5:1 to 35:1, preferably from 7:1 to 30:1. The diameter of spherical parts is 5 to 150, preferably 20 to 100 μm.

In the process according to the invention, the reinforcing agents are added in amounts of preferably from 10 to 35 wt. %, more preferably from 10 to 30 wt. %, based on the total amount of the components A and B.

As described above, a so-called component A is reacted with a so-called component B, the component A preferably containing the modified rubber gels (C).

The modified rubber gels are preferably types which have groups reactive towards isocyanates.

The preparation and characterization of crosslinked rubber microgels are described in U.S. Pat. No. 5,395,891 (BR microgels), U.S. Pat. No. 6,127,488 (SBR microgels) and DE-A 19 701 487 (NBR microgels). The microgels described in these documents are not modified by special functional groups.

Rubber microgels containing special functional groups are described in U.S. Pat. No. 6,184,296, DE-A 19 919 459 and DE-A 10 038 488. In these publications the functionalized microgels are prepared in several process steps. In the first step the base rubber latex is prepared by emulsion polymerization. As an alternative, it is also possible to use commercially available rubber latices as starting materials. The desired degree of crosslinking (characterized by gel content and swelling index) is adjusted in a downstream process step, preferably by crosslinking the rubber latex with an organic peroxide. DE-A 10 035 493 describes how to carry out the crosslinking reaction with dicumyl peroxide. The functionalization is performed after the crosslinking reaction. In U.S. Pat. No. 6,184,296, the crosslinked rubber particles are modified by sulfur or sulfur-containing compounds, and in DE-A 19 919 459 and DE-A 10 038 488 the crosslinked rubber latices are grafted with functional monomers such as hydroxyethyl methacrylate and hydroxybutyl acrylate.

The microgels used can also be prepared in a 1-stage process in which the crosslinking and the functionalization are performed during the emulsion polymerization.

The rubber particles used have diameters preferably of 5 to 1,000 nm, more preferably of 10 to 600 nm (diameter data according to DIN 53 206). Their crosslinking makes them insoluble and swellable in suitable precipitating agents, e.g. toluene. The swelling indices of the rubber particles (Sᵢ) in toluene are preferably 1 to 15, more preferably 1 to 10. The swelling index is calculated from the weight of the solvent-containing gel (after centrifugation at 20,000 rpm) and the weight of the dry gel, where Sᵢ=wet weight of gel/dry weight of gel. The gel content of the rubber particles is preferably 80 to 100 wt. %, more preferably 90 to 100 wt. %.

The rubber microgels or their dispersions are described in detail in WO 2005/033186, WO 2005/030843 and in the German patent application with the application number 10 2004 062551.4 which content is included herewith and is part of this specification.

The component A1) can contain aromatic diamines which have an alkyl substituent in at least one ortho position to the amino groups, and a molecular weight of 122 to 400. Particularly preferred aromatic diamines are those which have at least one alkyl substituent in the ortho position to the first amino group and two alkyl substituents in the ortho position to the second amino group, said alkyl substituents each having 1 to 4 carbon atoms, preferably 1 to 3 carbon atoms. Very particularly preferred aromatic diamines are those which have an ethyl, n-propyl and/or isopropyl substituent in at least one ortho position to the amino groups and optionally methyl substituents in other ortho positions to the amino groups. Examples of such diamines are 2,4-diaminomesitylene, 1,3,5-triethyl-2,4-diaminobenzene and its technical-grade mixtures with 1-methyl-3,5-diethyl-2,6-diaminobenzene, or 3,5,3′,5′-tetraisopropyl-4,4′-diaminodiphenylmethane. Of course, mixtures with one another can also be used. Particularly preferably, the component A1) is 1-methyl-3,5-diethyl-2,4-diaminobenzene or its technical-grade mixtures with 1-methyl-3,5-diethyl-2,6-diaminobenzene (DETDA).

The component A2) contains at least one aliphatic polyetherpolyol or polyesterpolyol of molecular weight 500 to 18,000, more preferably 1,000 to 16,000 and most preferably 1,500 to 15,000, having hydroxyl and/or primary amino groups. The component A2) possesses the aforementioned functionalities. The polyetherpolyols can be prepared in a known manner by the alkoxylation of starter molecules or their mixtures of corresponding functionality, the alkoxylation being carried out using especially propylene oxide and ethylene oxide. Suitable starters or starter mixtures are sucrose, sorbitol, pentaerythritol, glycerol, trimethylenepropane, propylene glycol and water. Preferred polyetherpolyols are those in which at least 50%, more preferably at least 70% and especially all of the hydroxyl groups are primary hydroxyl groups.

Particularly suitable polyesterpolyols are those made up of the dicarboxylic acids known for this purpose, such as adipic acid and phthalic acid, and polyhydric alcohols such as ethylene glycol, 1,4-butanediol and optionally proportions of glycerol and trimethylolpropane.

Such polyetherpolyols and polyesterpolyols are described e.g. in Kunststoffhandbuch 7, Becker/Braun, Carl Hanser Verlag, 3rd edition, 1993.

Polyetherpolyols and/or polyesterpolyols having primary amino groups, such as those described e.g. in EP-A 219 035 and known as ATPE (amino-terminated polyethers), can also be used as the component A2).

The so-called JEFFAMINES from Texaco, composed of α,ω-diaminopolypropylene glycols, are particularly suitable as polyetherpolyols and/or polyesterpolyols having amino groups.

The known catalysts for the urethane and urea reaction, such as tertiary amines or the tin(II) or tin(IV) salts of higher carboxylic acids, can be used as the component A4). Other additives used are stabilizers such as the known polyethersiloxanes, or mold release agents such as zinc stearate. The known catalysts or additives are described e.g. in chapter 3.4 of Kunststoffhandbuch 7, Polyurethane, Carl Hanser Verlag (1993), pp 95 to 119, and can be used in the recommended amounts.

The so-called component B is an NCO prepolymer based on the polyisocyanate component B1) and the polyol component B2) and has an NCO content of 8 to 32 wt. %, preferably of 12 to 26 wt. % and particularly preferably of 12 to 25 wt. %.

The polyisocyanates B1) are polyisocyanates or polyisocyanate mixtures of the diphenylmethane series, optionally liquefied by chemical modification. By the expression “polyisocyanate of the diphenylmethane series” is meant all polyisocyanates formed in the phosgenation of aniline/formaldehyde condensation products and present as individual components in the phosgenation products. The expression “polyisocyanate mixture of the diphenylmethane series” denotes any mixtures of polyisocyanates of the diphenylmethane series, for example said phosgenation products, the mixtures obtained as distillate or distillation residue in the distillative separation of such mixtures, and any mixtures of polyisocyanates of the diphenylmethane series.

Examples of suitable polyisocyanates B1) are 4,4′-diisocyanatodiphenylmethane, its mixtures with 2,2′- and especially 2,4′-diisocyanatodiphenylmethane, mixtures of these diisocyanatodiphenylmethane isomers with their higher homologues, such as those obtained in the phosgenation of aniline/formaldehyde condensation products, diisocyanates and/or polyisocyanates modified by partial carbodiimidization of the isocyanate groups of said diisocyanates and/or polyisocyanates, or any mixtures of such polyisocyanates.

Compounds that are particularly suitable as the component B2) are the polyether-polyols or polyesterpolyols corresponding to this definition, or mixtures of such polyhydroxyl compounds. Possible examples are corresponding polyetherpolyols optionally containing organic fillers in dispersed form. Examples of these dispersed fillers are vinyl polymers, such as those formed e.g. by the polymerization of acrylonitrile and styrene in polyetherpolyols as reaction medium (U.S. Pat. No. 3,383,351, 3,304,273, 3,523,093, 3,110,695, DE-PS 11 52 536), or polyureas or polyhydrazides, such as those formed by a polyaddition reaction between organic diisocyanates and diamines or hydrazine in polyetherpolyols as reaction medium (DE-PS 12 60 142, DE-OS 24 23 984, 25 19 004, 25 13 815, 25 50 833, 25 50 862, 26 33 293 or 25 50 796). In principle, polyetherpolyols or polyesterpolyols of the type already mentioned under A2) above are suitable as the component B2) provided they correspond to the characteristics mentioned below.

The polyol component B2) has an average molecular weight preferably of from 1,000 to 16,000, especially of 2,000 to 16,000, coupled with an average hydroxyl functionality of 3 to 8, more preferably of 3 to 7.

The NCO semi-prepolymers B) are preferably prepared by reacting the components B1) and B2) in proportions (NCO in excess) such that the resulting NCO semi-prepolymers have the NCO content mentioned above. The appropriate reaction is generally carried out within the temperature range from 25 to 100° C. In the preparation of the NCO semi-prepolymers it is preferable to react the total amount of the polyisocyanate component B1) with the total amount of the component B2) intended for the preparation of the NCO semi-prepolymers.

The elastomers according to the invention are produced by the known reaction injection molding technique (RIM process), as described e.g. in DE-AS 2 622 951 (U.S. Pat. No. 4,218,543) or DE-OS 39 14 718, the proportions of the components A) and B) corresponding to the stoichiometric proportions with an NCO index of 80 to 120. Also, the amount of reaction mixture introduced into the mold is measured so that the moldings have a density of at least 0.8, preferably of 1.0 to 1.4 g/cm³. The density of the resulting moldings is of course largely dependent on the type and proportion by weight of the fillers used. In general, the moldings according to the invention are microcellular elastomers, i.e. not true foams having a foam structure visible to the naked eye. This means that any organic blowing agents used perform the function of a flow control agent rather than that of a true blowing agent.

The starting temperature of the reaction mixture of the components A) and B) introduced into the mold is generally 20 to 80, preferably 30 to 70° C. The temperature of the mold is generally 30 to 130, preferably 40 to 80° C. The molds used are those of the type known in the art, preferably made of aluminum or steel, or epoxy molds spray-coated with metal. The demolding properties can optionally be improved by coating the internal walls of the mold used with known external mold release agents.

The moldings formed in the mold can generally be released after a mold residence time of 5 to 180 seconds. The demolding is optionally followed by after-baking at a temperature of approx. 60 to 180° C. for a period of 30 to 120 minutes.

The PU moldings produced in this way, preferably sheet moldings, are particularly suitable for the production of flexible car bumpers or flexible body elements such as car doors and rear flaps or wings.

The invention will be illustrated in greater detail by means of the Examples which follow.

### EXAMPLES

Starting Materials

Semi-prepolymer 1—91.8 parts by weight of 4,4′-diisocyanatodiphenylmethane were reacted at 90° C. with 66.4 parts by weight of polyetherpolyol 1. NCO content after 2 hours: 18.0%

Polyol 1—Polyetherpolyol of OH number 28, prepared by propoxylation of the hexafunctional starter sorbitol, followed by ethoxylation in proportions of 83:17, having predominantly primary OH groups.

DETDA—Mixture of 80 wt. % of 1-methyl-3,5-diethyl-2,4-diaminobenzene and 20 wt. % of 1-methyl-3,5-diethyl-2,6-diaminobenzene

Jeffamine D 400—Aliphatic diamine from Texaco

DABCO 33 LV—1,4-Diazabicyclo[2.2.2]octane (33 wt. % in dipropylene glycol) from Air Products

Tremin 939-955—Wollastonite from Quarzwerke Frechen

The formulations described below were processed by the reaction injection molding technique. After intimate mixing in a mixing head with forced control, the components A and B were injected from a high-pressure metering device via a sprue with restrictor bar into a heated platen mold of dimensions 300×200×3 mm at a mold temperature of 80° C.

The temperature of the component A was 60° C. and the temperature of the component B was 50° C.

The mechanical values were measured following after-baking in a re-circulating air dryer for 45 minutes at 160° C. and then storage for 24 hours.

Before each run the mold was treated with the mold release agent RTWC 2006 from Chem Trend.

Preparation of the Modified Rubber Gels (“microgel A”)

The rubber gel was prepared according to the German patent application with the application number 10 2004 062551.4 which was filed on Dec. 24, 2004 at the German Patent and Trademark Office (Applicant: Rhein Chemie Rheinau GmbH); Microgel OBR 1320 D.

Polyol formulation 1:

| Polyol 1 | 52.4 wt. % |
|---|---|
| DETDA | 42.1 wt. % |
| Zn stearate | 2.0 wt. % |
| Jeffamine D 400 | 3.0 wt. % |
| DABCO 33 LV | 0.3 wt. % |
| DBTDL (dibutyltin dilaurate) | 0.2 wt. % |
| OH number | 289.2 |

Preparation of the rubber gel dispersion:

The rubber gel dispersion was prepared according to the German patent application with the application number 10 2004 062551.4:

850 parts by weight of polyol formulation 1 and 150 parts by weight of the rubber gel (microgel A) were used.

66.67 parts by weight of this rubber gel dispersion and 33.33 parts by weight of polyol formulation 1 were then stirred together and subsequently mixed with 65.3 parts by weight of Tremin 939-955 from Quarzwerke Frechen, and the mixture was injected with 118.4 parts by weight of prepolymer 1 into a mould of dimensions 200×300×3 mm, heated to 60° C., under the processing conditions conventionally employed for the RIM technique (index 105).

| | |
|---|---|
| Temperature of the polyol formulation: | 60° C. |
| Temperature of the prepolymer: | 50° C. |
| Bulk density of the polyurethane-urea elastomer: | 1250 kg/m³ |

The molding was after-baked for 45 min at 160° C. After storage for 24 hours, the board was bent and fixed and the bending seam was then trodden on.

Even after being trodden on several times, the board could not be broken.

A board based on 100 parts by weight of polyol formulation 1 with 65.3 parts by weight of Tremin 939-955 from Quarzwerke Frechen and 131.5 parts by weight of prepolymer 1 was produced under the same conditions and treated similarly. Here again the index was 105. After being trodden on only once, the board broke at the bending seam.

The tenacity of the reinforced polyurethane-urea elastomer could be substantially improved by using the rubber gels, as shown by the result of the treading stress test. The elongation at break and the low-temperature tenacity according to DIN 53 435-DS at −25° C. are also improved (cf. Table 2).

TABLE 2
Mechanical properties

| | Microgel/PUR-urea | PUR-urea elastomer |
|---|---|---|
| Test parameter | elastomer | (Comparative) |
| Flexural modulus according to | 1950 MPa | 1900 MPa |
| ASTM 790 | | |
| Elongation at break according | 100% | 60% |
| to DIN 53 504 | | |
| Dynstat at −25° C. according | 33 kJ/m² | 16 kJ/m² |
| to DIN 53 435-DS | | |
| (low-temperature tenacity) | | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A molding comprising one or more polyurethane-urea elastomers, having a urea content of from about 70 to about 95 mol % and a urethane content of from about 9 to about 30 mol %, based in each case on mol % of an NCO equivalent, the elastomers produced by reacting:
a component A containing
A1) one or more aromatic diamines having an alkyl substituent in at least one ortho position to the amino groups,
A2) an aliphatic component consisting of at least one polyetherpolyol and/or polyesterpolyol having a number-average molecular weight of from about 500 to about 18,000 and a functionality of from about 3 to about 8 and having at least one of hydroxyl and primary amino groups,
A3) a reinforcing agent; and
A4) optionally catalysts and/or optionally additives,
with a component B produced by reacting
B1) a polyisocyanate component chosen from polyisocyanates and polyisocyanate mixtures of the diphenylmethane series and liquefied polyisocyanates of the diphenylmethane series, with
B2) at least one polyol component having a number-average molecular weight of from about 500 to about 18,000 and a functionality of from about 3 to about 8 chosen from polyetherpolyols optionally containing organic fillers and polyesterpolyols optionally containing organic fillers,
wherein at least one of component A and component B contains rubber gels (C) modified by groups reactive towards isocyanate groups.

2. In a process for making an external vehicle body part, the improvement comprising including the molding according to claim 1.

3. The process according to claim 2, wherein the external vehicle body part is chosen from flexible car bumpers, wings, doors and rear flaps.

4. The molding according to claim 1, wherein the rubber gels (C) are made from at least one rubber chosen from polybutadiene, butadiene/C₁-C₄-alkyl acrylate copolymers, polyisoprene, styrene/butadiene copolymers with styrene contents of from about 1 to about 60, carboxylated styrene/butadiene copolymers, fluorinated rubber, acrylate rubber, polybutadiene/acrylonitrile copolymers with acrylonitrile contents of from about 5 to about 60, carboxylated nitrile rubbers, polychloroprene, isobutylene/isoprene copolymers with isoprene contents of from about 0.5 to about 10 wt. %, brominated isobutylene/isoprene copolymers with bromine contents of from about 0.1 to about 10 wt. %, chlorinated isobutylene/isoprene copolymers with bromine contents of about 0.1 to about 10 wt. %, partially and fully hydrogenated nitrile rubbers, ethylene/propylene/diene copolymers, ethylene/acrylate copolymers, ethylene/vinyl acetate copolymers and epichlorohydrin rubbers.

5. The molding according to claim 1 having a urea content of from about 75 to about 90 mol % and a urethane content of from about 10 to about 25 mol %.

6. The molding according to claim 1, wherein the reinforcing agents comprise from about 10 to about 35 wt. %, based on the total amount of the components A and B.

7. The molding according to claim 1, wherein the reinforcing agents comprise from about 10 to about 30 wt. %, based on the total amount of the components A and B.

8. The molding according to claim 1, wherein the modified rubber gels (C) are contained in component A.

9. The molding according to claim 1, wherein component B has an NCO content of from about 8 to about 32 wt. %.

10. The molding according to claim 1, wherein component B has an NCO content of from about 12 to about 26 wt. %.

11. The molding according to claim 1, wherein component B has an NCO content of from about 12 to about 25 wt. %.
